(19) United States
(12) Patent Application Publication
(10) Pub. No.: US 2010/0197270 A1
(43) Pub. Date: Aug. 5, 2010

(54) TELEPHONE SERVER AND COMPUTER READABLE MEDIUM

(75) Inventor: Yasuhiro KUDO, Ichinomiya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/700,221

(22) Filed: Feb. 4, 2010

(30) Foreign Application Priority Data
Feb. 4, 2009 (JP) 2009-024173

(51) Int. Cl. H04M 3/16

(52) U.S. Cl. 455/410

(57) ABSTRACT

The first telephone server may be configured so as to be capable of communicating with a second telephone server with which a first wireless telephone device is registered. The first telephone server may be configured to receive authentication information sent from the first wireless telephone device located within a wireless communication area of the first telephone server. The first telephone server may be configured to send a first command including the authentication information to the second telephone server. The first telephone server may be configured to receive a first response sent in response to the first command from the second telephone server. The first telephone server may be configured to receive a call request, sent from the first wireless telephone device to a second wireless telephone device, by using a wireless communication. The first telephone server may be configured to send the call request to the second wireless telephone device by using the wireless communication without utilizing the second telephone server on a condition that the first response is a positive response and the second wireless telephone device is located within the wireless communication area. The first telephone server may be configured to receive, by means of wireless communication, a second response sent in response to the first command from the second wireless telephone device. The first telephone server may be configured to send the second response to the first wireless telephone device by using the wireless communication.

### CROSS-REFERENCE TO RELATED APPLICATIONS

This application claims priority to Japanese Patent Application No. 2009-024173, filed on Feb. 4, 2009, the contents of which are hereby incorporated by reference into the present application.

### TECHNICAL FIELD

The present specification discloses a technique for relaying a call request sent from a wireless telephone device.

### DESCRIPTION OF RELATED ART

A technique is known for a wireless telephone device to perform telephone communication with another wireless telephone device via an access point. In this technique, the wireless telephone device performs telephone communication with the other wireless telephone device using a SIP (Session Initiation Protocol). Each wireless telephone device is registered with a SIP server. For example, if a first wireless telephone device needs to send a call request to a second wireless telephone device, the first wireless telephone device sends the call request to an access point. The access point transfers the call request to the SIP server. The SIP server transfers the call request to the second wireless telephone device via the access point.

### SUMMARY

In the above technique, each telephone device that performs telephone communication is registered with one telephone server (e.g. SIP server). A system utilizing a plurality of telephone servers is not disclosed. The present specification discloses a technique that is capable of efficiently performing communication in a system utilizing a plurality of telephone servers.

One technique disclosed by the present specification is a first telephone server. The first telephone server is configured so as to be capable of communicating with a second telephone server with which a first wireless telephone device is registered. The first telephone server comprises an authentication information receiving unit, a first command sending unit, a first response receiving unit, a call request receiving unit, a call request sending unit, a second response receiving unit, and a second response sending unit. The authentication information receiving unit is configured to receive authentication information sent from the first wireless telephone device located within a wireless communication area of the first telephone server. The first command sending unit is configured to send a first command including the authentication information to the second telephone server. The first response receiving unit is configured to receive a first response, which includes an authentication result based on the authentication information included in the first command, sent in response to the first command from the second telephone server. The call request receiving unit is configured to receive a call request, sent from the first wireless telephone device to a second wireless telephone device, by using a wireless communication. The call request sending unit is configured to send the call request to the second wireless telephone device by using the wireless communication without utilizing the second telephone server on a condition that the first response received by the first response receiving unit is a positive response which includes the authentication result indicating that authentication has succeeded and the second wireless telephone device is located within the wireless communication area. The second response receiving unit is configured to receive, by using the wireless communication, a second response sent in response to the first command from the second wireless telephone device. The second response sending unit is configured to send the second response to the first wireless telephone device by using the wireless communication.

### BRIEF DESCRIPTION OF THE DRAWINGS

FIG. 1 shows an example of a wireless telephone system comprising a plurality of telephone servers.

FIG. 2 shows a sequence view of an example of telephone communication of a wireless telephone system.

FIG. 3 shows a sequence view of an example of telephone communication of a wireless telephone system.

FIG. 4 shows a wireless telephone system of a present embodiment.

FIG. 5 shows a schematic configuration of a telephone server.

FIG. 6 shows an example of a registration information table.

FIG. 7 shows a schematic configuration of a telephone device.

FIG. 8 shows a sequence view of an example of a connection process.

FIG. 9 shows a sequence view of an example of a connection process in a case where a telephone server which is a connection destination of the telephone device is changed.

FIG. 10 shows a sequence view of an example of a process in a case where the telephone device starts telephone communication with another telephone device.

FIG. 11 shows a sequence view of an example of a process in the case where the telephone device starts telephone communication with another telephone device.

FIG. 12 shows a sequence view of an example of a process in a case where a telephone server which is a main connection destination of the telephone device is changed.

### EMBODIMENT

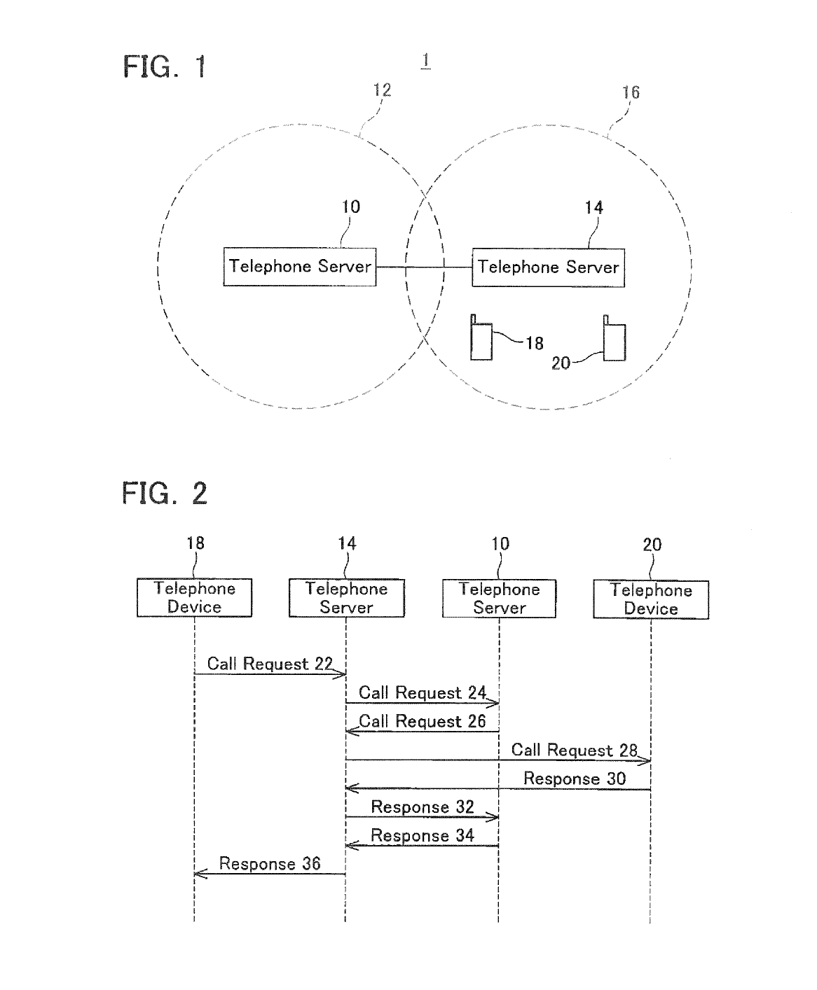

In the present specification, a configuration is taught in which a telephone server is installed at each access point in a wireless telephone system provided with a plurality of access points. The plurality of telephone servers herein each functions as an access point. FIG. 1 to FIG. 3 are merely examples, and should not be interpreted as limiting the scope of the technology herein taught. As shown in FIG. 1, a wireless telephone system 1 comprises wireless telephone devices 18, 20, and telephone servers 10, 14 that respectively have a wireless communication area 12, 16. The telephone server 10 is connected communicably with the telephone server 14. The wireless telephone device 18 is registered with the telephone server 10. The wireless telephone device 20 is registered with the telephone server 14. The wireless telephone devices 18, 20 are located within the wireless communication area 16.

In a case shown in FIG. 2, the wireless telephone device 18 sends a call request to the wireless telephone device 20. The wireless telephone device 18 sends a call request 22, which a destination thereof is the wireless telephone device 20, to the telephone server 14 that is capable of communicating with the wireless telephone device 18. Upon receiving the call request 22 from the wireless telephone device 18, the telephone server 14 sends a call request 24 to the telephone server 10 with which the wireless telephone device 18 is registered. The telephone server 10 sends a call request 26 to the telephone server 14 that is capable of communicating wirelessly with the wireless telephone device 20, which is the destination of the call request 24. Upon receiving the call request 26 from the telephone server 10, the telephone server 14 sends a call request 28 to the wireless telephone device 20. The wireless telephone device 20 sends, to the telephone server 14, a response 30 to the call request 28. The telephone server 14 sends a response 32 to the telephone server 10 with which the wireless telephone device 18, which is the destination of the response 30, is registered. The telephone server 10 sends a response 34 to the telephone server 14 that is capable of performing wireless communication with the wireless telephone device 18, which is the destination of the response 32. The telephone server 14 sends a response 36 to the wireless telephone device 18. The wireless telephone device 18 and the wireless telephone device 20 thus assume a state of being able to communicate with each other.

In the configuration of FIG. 2, since the wireless telephone device 18 and the wireless telephone device 20 are each registered with different telephone servers, commands (call requests and responses) for performing telephone communication between the wireless telephone device 18 and the wireless telephone device 20 are communicated between the telephone server 10 and the telephone server 14. In order to reduce the communication load between the telephone servers 10 and 14, the present inventors created a telephone server having the configuration below.

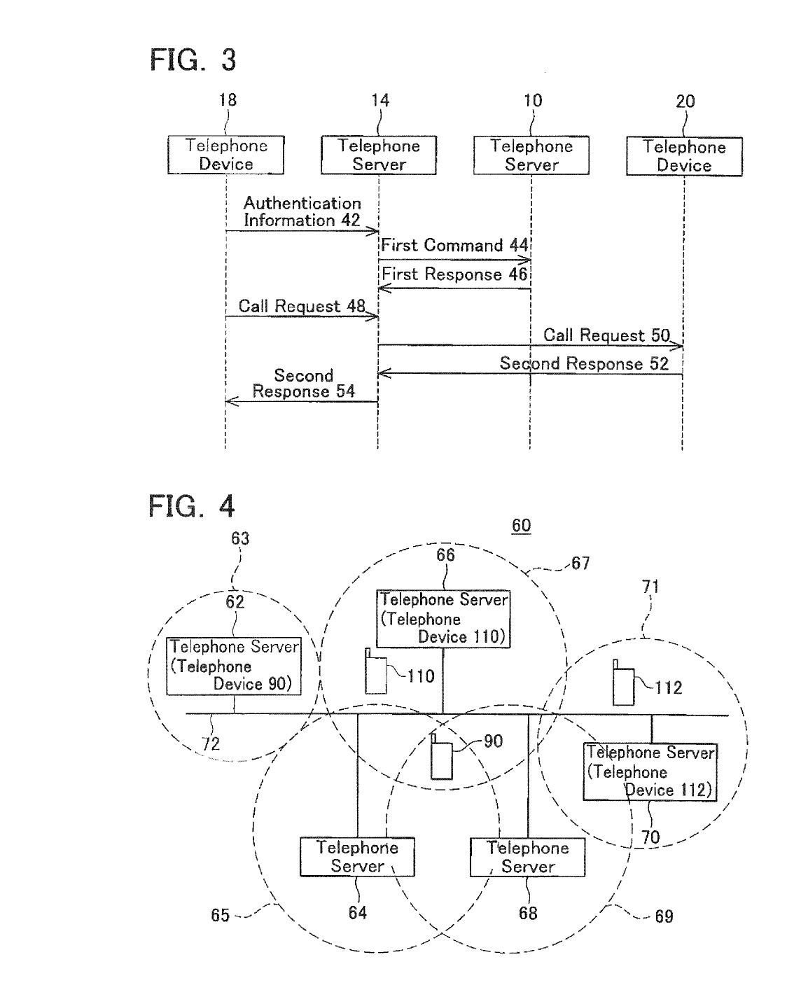

As shown in FIG. 3, the telephone server 14 is capable of communicating with the other telephone server 10 with which the first wireless telephone device 18 is registered, and has the wireless communication area 16. The telephone server 14 comprises an authentication information receiving unit, a first command sending unit, a first response receiving unit, a call request receiving unit, a call request sending unit, a second response receiving unit, and a second response sending unit. The authentication information receiving unit is configured to receive, by using a wireless communication, authentication information 42 sent from the first wireless telephone device 18 located within the wireless communication area 16. The authentication information 42 is information for the other telephone server 10 to authenticate the first wireless telephone device 18. Examples of the authentication information 42 are a device ID, password, etc. The first command sending unit is configured to send a first command 44 including the authentication information 42 to the other telephone server 10. Consequently, the other telephone server 10 utilizes the authentication information 42 included in the first command 44 to authenticate the first wireless telephone device 18. The other telephone server 10 sends the first response 46 including the authentication result of the first wireless telephone device 18 to the telephone server 14. The first response receiving unit is configured to receive the first response 46 sent from the other telephone server 10 in response to the first command 44. The call request receiving unit is configured to receive, by using the wireless communication, a call request 48 sent from the first wireless telephone device 18 to the second wireless telephone device 20. The call request sending unit is configured to send a call request 50 to the second wireless telephone device 20 by the wireless communication without utilizing the other telephone server 10 on a condition that the first response 46 received by the first response receiving unit is a positive response and the second wireless telephone device 20 is located within the wireless communication area 16. The second response receiving unit is configured to receive, by using the wireless communication, a second response 52 sent from the second wireless telephone device 20 in response to the call request 50. The second response sending unit is configured to send a second response 54 to the first wireless telephone device 18 by the wireless communication.

If the telephone server 14 is utilized, in the case where the positive first response 46 has been received response to the first command 44, commands (the call requests 48, 50 and second responses 52, 54) for performing telephone communication between the first wireless telephone device 18 and the second wireless telephone device 20 are communicated without utilizing the telephone server 10 with which the first wireless telephone device 18 is registered. Compared to the configuration of FIG. 2, the communication load between the telephone servers 10, 14 can be reduced.

The telephone server 14 may further comprise a registration information storing unit, a command receiving unit, and a positive response sending unit. The registration information storing unit may be configured to store registration information including the authentication information of a wireless telephone device. The command receiving unit may be configured to receive a second command sent from the other telephone server 10 and including authentication information of a third wireless telephone device. The positive response sending unit may be configured to send a positive response in response to the second command to the other telephone server 10 on a condition that the authentication information of the third wireless telephone device included in the second command received by the command receiving unit is stored in the registration information storing unit.

The telephone server 14 may be connected communicably with a third telephone server other than the other telephone server 10. In this case, the telephone server 14 may further comprise an authentication notice sending unit. The authentication notice sending unit may be configured to send a first authentication notice, which indicates that authentication of the first wireless telephone device 18 has succeeded, to the third telephone server on a condition that the first response received by the first response receiving unit is a positive response. According to this configuration, the third telephone server can learn whether authentication of the first wireless telephone device 18 has succeeded without performing the authentication process (including receiving authentication information, sending commands, and responses) of the first wireless telephone device 18.

The telephone server 14 may further comprise an authentication notice receiving unit and a session establishing unit. The authentication notice receiving unit may be configured to receive a second authentication notice sent from the other telephone server 10 which indicates that authentication of a fourth wireless telephone device has succeeded. The session establishing unit may be configured to establish a session of wireless communication with the fourth wireless telephone device on a condition that the second authentication notice has been received by the authentication notice receiving unit and the fourth wireless telephone device is located within the wireless communication area 16. “Establishing a session of wireless communication” means that e.g., if the telephone server 14 receives a connection request sent from the fourth wireless telephone device, the telephone server 14 performs a process required for wireless communication with the fourth wireless telephone device. Consequently, the phrase “establish a session of wireless communication with the fourth wireless telephone device” can also be phrased as “connect so as to be capable of performing wireless communication with the fourth wireless telephone device” or “establish a communication path with the fourth wireless telephone device”. The telephone server 14 may also request information from the fourth wireless telephone device required to establish a session of wireless communication with the fourth wireless telephone device.

For example, the fourth wireless telephone device that is located in the wireless communication area 12 of the telephone server 10, and is performing telephone communication with another telephone device using the telephone server 10 as its access point can move from the wireless communication area 12 of the telephone server 10 to the wireless communication area 16 of the telephone server 14. In this case, the fourth wireless telephone device attempts wireless communication with the telephone server 14. If a communication session between the telephone server 14 and the fourth wireless telephone device has been established in advance, time for the fourth wireless telephone device to start wireless communication with the telephone server 14 can be reduced. Telephone communication cut off time between the fourth wireless telephone device and the other telephone device can thereby be reduced.

### Configuration of System

The embodiment will be explained with reference to the figures. As shown in FIG. 4, the wireless telephone system 60 comprises telephone servers 62, 64, 66, 68, 70, telephone devices 90, 110, 112, etc. The telephone servers 62, 64, 66, 68, 70 are connected with a LAN circuit 72. In FIG. 4, only five telephone servers 62, 64, 66, 68, 70 are shown. However, more telephone servers may be provided. Further, in FIG. 4 only three telephone devices 90, 110, 112 are shown. However, more telephone devices may be provided. The telephone devices 90, 110, 112 are portable telephone devices (e.g. mobile phone, PDA, etc.).

The telephone devices 90, 110, 112 can perform wireless telephone communication utilizing SIP. In order to perform wireless telephone communication utilizing a SIP, a SIP server is required. In a case where a telephone device is registered with a SIP server, a SIP URI (SIP Uniform Resource Identifier) corresponding to the SIP server is assigned to the telephone device. In the present embodiment, each telephone server 62, 64, 66, 68, 70 functions as a SIP server. The telephone device 90 is registered with the telephone server 62. The telephone device 110 is registered with the telephone server 66. The telephone device 112 is registered with the telephone server 70. In FIG. 4, the contents of the brackets of the telephone servers 62, 66, 70 indicate the telephone devices 90, 110, 112 registered with the telephone servers 62, 66, 70. A specific SIP URI is assigned to each telephone device 90, 110, 112. The SIP URIs of the telephone devices 90, 110, 112 include the URIs of the telephone servers 62, 66, 70 with which the telephone devices are registered. E.g., the SIP URI “sip:aaa@server62.com” of the telephone device 90 registered with the telephone server 62 includes the URI “server62.com” of the telephone server 62. Similarly, the SIP URI “sip:bbb@server66.com” of the telephone device 110 registered with the telephone server 66 includes the URI “server66.com” of the telephone server 66, and the SIP URI of the telephone device 112 registered with the telephone server 70 includes the URI of the telephone server 70.

### Configuration of Telephone Server

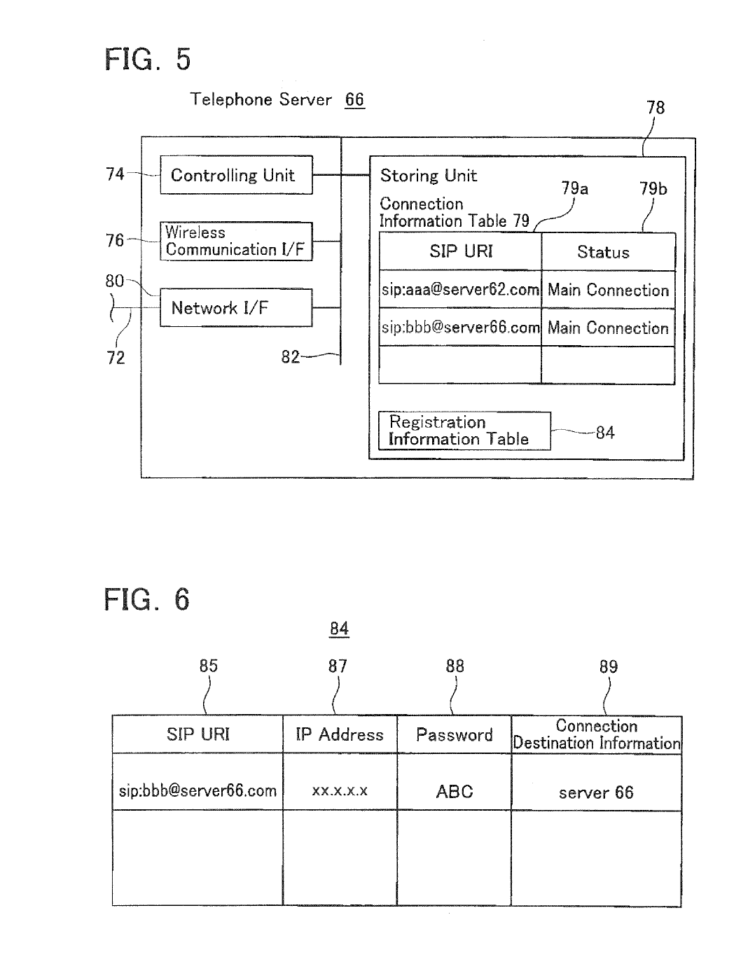

As shown in FIG. 5, the telephone server 66 comprises a controlling unit 74 and wireless communication interface 76 (termed wireless communication OF 76 in FIG. 5 and below), a network interface 80 (termed network I/F 80 in FIG. 5 and below), a storing unit 78. Each unit 74, 76, 78, 80 of the telephone server 62 is connected by a bus 82. The controlling unit 74 performs various processes in accordance with a program stored in the storing unit 78. The program stored in the storing unit 78 may have been installed from a computer readable medium storing the program. The contents of the processes performed by the controlling unit 74 will be explained in detail later. The wireless communication I/F 76 has a wireless communication area 67 shown in FIG. 4. The wireless communication I/F 76 is an interface for wireless communication with a telephone device located in the wireless communication area 67. The telephone server 66 relays the wireless telephone communication of the telephone device via the wireless communication I/F 76. I.e., the telephone server 66 functions as an access point of the telephone device. The controlling unit 74 transmits an identification signal (beacon signal) within the wireless communication area 67 at a predetermined time interval via the wireless communication I/F 76. Identification information of the telephone server 66 (e.g., the URI of the telephone server 66) is included in the identification signal. The LAN circuit 72 is connected to the network I/F 80. The controlling unit 74 assigns an IP address to the telephone device that performs wireless communication. The telephone server 66 thereby functions as a DHCP server.

The storing unit 78 is composed of a ROM, EEPROM, RAM, etc. The storing unit 78 stores the URIs of the telephone servers 64, 68 neighbouring the telephone server 66. Further, the storing unit 78 stores a connection information table 79 and a registration information table 84. An association of a SIP URI 79a of the telephone device and status 79b of the connection is stared in the connection information table 79. The controlling unit 74 stores, in the SIP URI 79a, the SIP URI of a telephone device connected so as to be capable of performing wireless communication with the telephone server 66. The controlling unit 74 stores status indicating either “main connection” or “sub connection” in the status 79b in association with the SIP URI 79a of the telephone device connected so as to be capable of performing wireless communication with the telephone server 66. The controlling unit 74 stores, in the SIP URI 79a, the SIP URI of a telephone device authenticated by an authentication OK or authentication notice (to be described). In the present embodiment, the telephone devices 90, 110 have a main connection with the telephone server 66. The controlling unit 74 stores an association of the SIP URIs of the telephone devices 90, 110 and “main connection” in the connection information table 79. The manner in which the controlling unit 74 stores the SIP URI 79a and status 79b in the connection information table 79 will be explained later. The terms “main connection” and “sub connection” will also be explained later.

As shown in FIG. 6, an association of SIP URI 85 of the telephone device, IP address 87, password 88, and connection destination information 89 is stored in the registration information table 84. A designer, user, etc. can register the SIP URI of the telephone device and the password in the registration information table 84. In the present embodiment, the telephone device 110 is registered with the telephone server 66. Consequently, an association of the SIP URI 85 of the telephone device 110 and the password 88 is stored in the registration information table 84.

The connection destination information 89 is the URI of a telephone server capable of communicating wirelessly with the telephone device 110. In the present embodiment, since the telephone device 110 has become capable of communicating wirelessly with the telephone server 66, “server 66” is stored. The controlling unit 74 is capable of updating the IP address 87 and connection destination information 89. If the telephone device 110 is located within a wireless communication area 65 of the telephone server 64, then the telephone server 64 sends, to the telephone server 66, the IP address of the telephone device 110 and an acknowledgement (connection destination acknowledgement) indicating that the telephone device 110 is located within the wireless communication area 65. In a case where this acknowledgement is received, the controlling unit 74 stores the URI “server64” of the telephone server 64 as the connection destination information 89 of the telephone device 110. Further, the controlling unit 74 stores the received IP address as the IP address 87 of the telephone device 110.

The telephone servers 62, 64, 68, 70 comprise the same configuration as the telephone server 66. Information relating to the telephone device 90 is registered in the registration information table of the telephone server 62. Information relating to the telephone device 112 is registered in the registration information table of the telephone server 70. An association of the SIP URI of the telephone device 112 and the status “main connection” is stored in the connection information table of the telephone server 70. The wireless communication I/Fs of the telephone servers 62, 64, 68, 70 have the respective wireless communication areas 63, 65, 69, 71.

### Configuration of Telephone Device

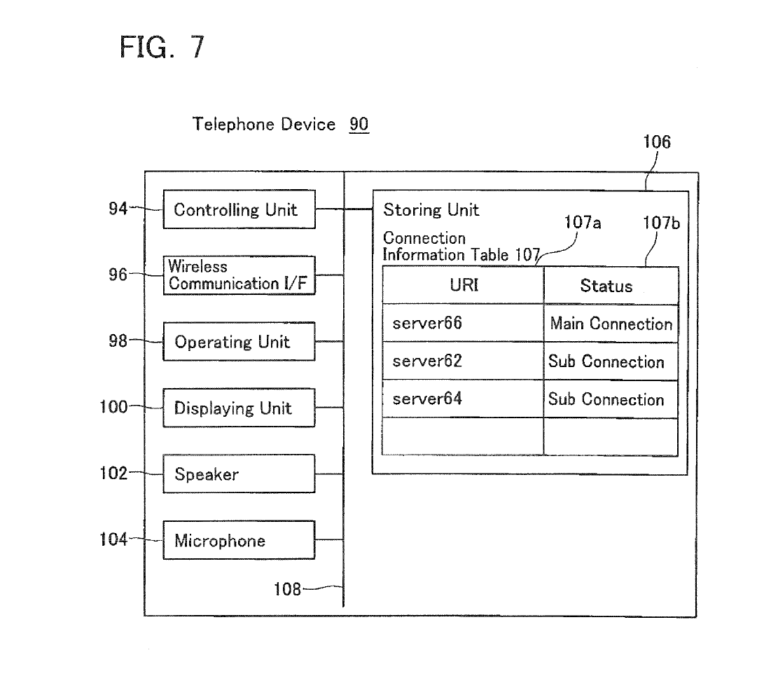

As shown in FIG. 7, the telephone device 90 comprises a controlling unit 94, a wireless communication interface 96 (termed wireless communication OF 96 in FIG. 7 and below), an operating unit 98, a displaying unit 100, a speaker 102, a microphone 104, a storing unit 106. The controlling unit 94 performs various processes in accordance with a program stored in the storing unit 106. The contents of the processes performed by the controlling unit 94 will be explained in detail later. The wireless communication I/F 96 is an interface for wireless communication with the telephone servers 62, 64, 66, 68, 70.

The operating unit 98 comprises a plurality of keys. For example, the operating unit 98 comprises a hook key (a call/end key) or number keys. The displaying unit 100 may display various information. A user may communicate utilizing the speaker 102 and the microphone 104. The storing unit 106 stores a program to be performed by the controlling unit 94. The storing unit 106 may store data generated by the controlling unit 94 performing processes. The storing unit 106 stores a password identical to the password 88 stored in association with the SIP URI 85 of the telephone device 90 in the registration information table 84. Further, the storing unit 106 stores a connection information table 107. An association of a URI 107a of the telephone server and status 107b is stored in the connection information table 107.

The telephone device 9n may be wirelessly connected (establish a communication session) with a plurality of telephone servers. The controlling unit 94 utilizes one telephone server, from among the plurality of wirelessly connected telephone servers, to perform telephone communication with another telephone device. The controlling unit 94 stores, in the connection information table 107, an association of “main connection” and the URI of the telephone server 66 that the telephone device 90 is utilizing in telephone communication. The controlling unit 94 stores, in the connection information table 107, an association of “sub connection” and the URI of the telephone servers 62, 64 that are wirelessly connected telephone servers and are not being utilized for communication with another telephone device. The telephone devices 110, 112 comprise the same configuration as the telephone device 90. An association of “main connection” and the URI of the telephone server 66 is stored in the connection information table of the telephone device 110. An association of “main connection” and the URI of the telephone server 70 is stored in the connection information table of the telephone device 112.

### Processes of Devices

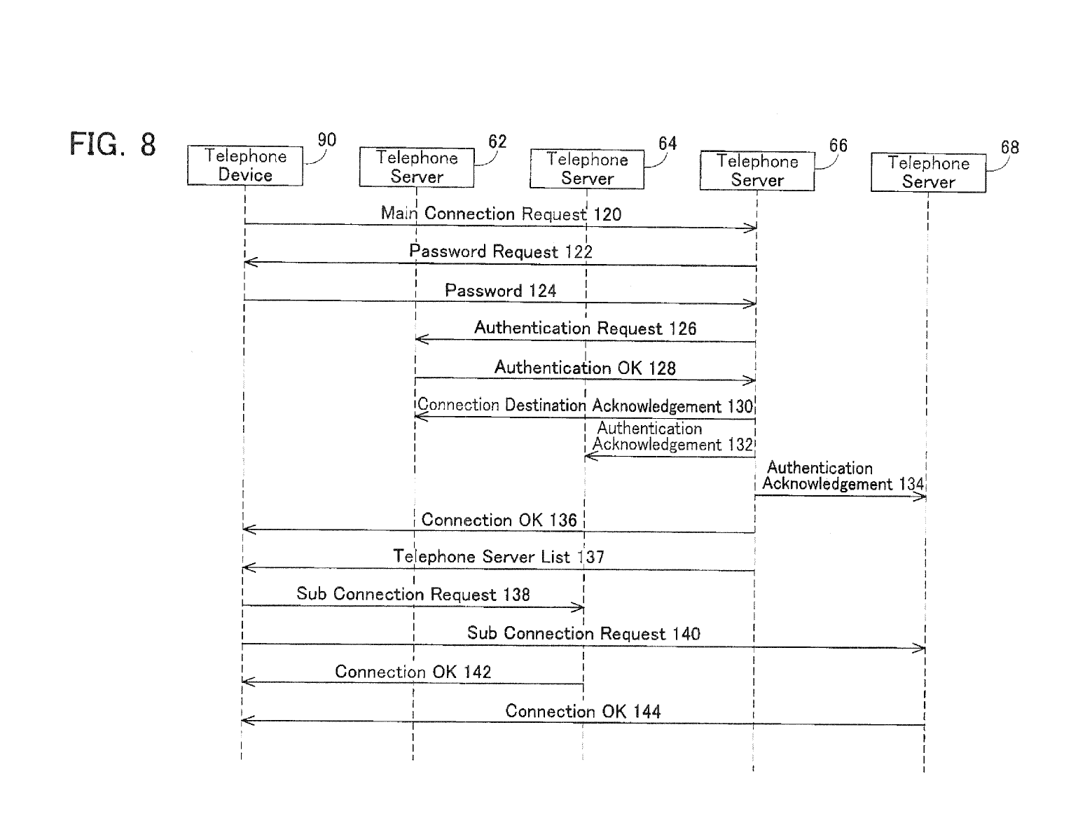

Next, the processes of the telephone device 90 and the telephone servers 62, 64, 66, 68 in the case where the telephone device 90 makes a main connection with the telephone server 66 will be explained with reference to FIG. 8. The description below indicates an example of a case where a power source of the telephone device 90 has been tamed ON in the location shown in FIG. 4 (i.e., within the wireless communication areas 65, 67, 69 of the telephone servers 64, 66, 68). The processes performed by the devices 90, 62, 64, 66, 68 are actually performed by the controlling units of those devices. The telephone device 90 is located within the wireless communication areas 65, 67, 69 of the telephone servers 64, 66, 68. The telephone device 90 receives identification signals transmitted regularly from the telephone servers 64, 66, 68. The telephone device 90 determines, from among the received identification signals, that the main connection should be made with the telephone server corresponding to the URI including the identification signal with the strongest signal intensity. Below, the case will be explained where the telephone server 66 is determined to be the telephone server with which the main connection should be made.

The telephone device 90 checks whether an association of “main connection” and the URI of the telephone server 66 with which main connection should be made is stored in the connection information table 107. If an association of “main connection” and the URI of the telephone server 66 is not stored, the telephone device 90 sends, to the telephone server 66, a main connection request 120 that includes its own SIP URI and information indicating that the connection request is the main connection request. If an association of “main connection” and the URI of the telephone server 66 is stored, the telephone device 90 does not send the main connection request 120. Upon receiving the main connection request 120, the telephone server 66 checks whether the SIP URI of the telephone device 90 included in the main connection request 120 is stored in the connection information table 79. If the SIP URI of the telephone device 90 is stored in association with “sub connection” in the connection information table 79, the telephone server 66 changes the status associated with the SIP URI included in the main connection request 120 from “sub connection” to “main connection”.

If the SIP URI of the telephone device 90 is stored in the connection information table 79 and status is not stored therein, the telephone server 66 determines that the telephone device 90 has been authenticated. A case of the telephone device 90 being authenticated, i.e., if the SIP URI of the telephone device 90 is stored in the connection information table 79 and status is not stored, is a case that the telephone server 66 has had received an authentication OK (an authentication OK 128: to be described) from the telephone server 62 with which the telephone device 90 is registered, or has had received an authentication notice (authentication acknowledgements 132, 134: to be described) of the telephone device 90 from another telephone server. If the telephone device 90 has been authenticated or if an association of “sub connection” and the SIP URI of the telephone device 90 is stored in the connection information table 79, the telephone server 66 determines the IP address assigned to the telephone device 90. The telephone server 66 connects wirelessly with the telephone device 90, and sends the IP address assigned thereto. Next, the telephone server 66 stores, in the connection information table 79, an association of “main connection” and the SIP URI of the telephone device 90. The telephone device 90 sets the received IP address as its own IP address. The IP address of the telephone device 90 is assigned by the telephone server that is the main connection. I.e., the IP address of the telephone device 90 changes depending on the telephone server that is the main connection. If the telephone device 90 has not been authenticated, i.e., if the SIP URI of the telephone device 90 is not stored in the connection information table 79, a password (authentication information) request 122 required for authenticating the telephone device 90 is sent.

Upon receiving the password request 122, the telephone device 90 sends a password 124 stored in the storing unit 106 to the telephone server 66. Upon receiving the password 124, the telephone server 66 specifies, from the SIP URI (sip:aaa@server62.com) included in the connection request 120 sent from the telephone device 90, that the telephone server with which the telephone device 90 is registered is the telephone server 62. Next, the telephone server 66 sends the authentication request 126 including the password 124 and the SIP URI of the telephone device 90 to the telephone server 62. Upon receiving the authentication request 126, the telephone server 62 checks whether an association of the SIP URI and the password included in the authentication request 126 is stored in its own registration information table. If aforesaid association is stored in the registration information table, the telephone server 62 sends an authentication OK 128, which includes the authentication result indicating that authentication of the telephone device 90 has succeeded, to the telephone server 66. If aforesaid association is not stored in the registration information table, the telephone server 62 sends an authentication error to the telephone server 66. Upon receiving the authentication OK 128 from the telephone server 62, the telephone server 66 determines the IP address assigned to the telephone device 90. The telephone server 66 sends, to the telephone server 62, a connection destination acknowledgement 130 including the SIP URI of the telephone device 90, its own URI, and the IP address assigned to the telephone device 90.

Upon receiving the connection destination acknowledgement 130, the telephone server 62 registers the IP address and the URI of the telephone server 66 associated with the SIP URI of the telephone device 90 stored in the registration information table. The URIs of the telephone servers 64, 68 neighbouring the telephone server 66 are stored in the storing unit 78 of the telephone server 66. Based on the URIs of the telephone servers 64, 68 stored in the storing unit 78, the telephone server 66 sends the authentication acknowledgements 132, 134 to the telephone servers 64, 68. The authentication acknowledgements 132, 134 include the SIP URI of the telephone device 90 and information indicating that authentication of the telephone device 90 has succeeded. The telephone servers 64, 68 that have received the authentication acknowledgements 132, 134 store the SIP URI of the telephone device 90 included in the authentication acknowledgements 132, 134 in the respective connection information tables. At this juncture, the telephone servers 64, 68 do not record the status of the respective connection information tables.

Next, the telephone server 66 sends, to the telephone device 90, a connection OK 136 including the IP address assigned to the telephone device 90 and the URI of the telephone server 66. The telephone server 66 stores an association of “main connection” and the SIP URI of the telephone device 90 in the connection information table 79. In a case where the telephone device 90 received the connection OK 136, the telephone device 90 stores an association of “main connection” and the URI of the telephone server 66 in the connection information table 107. If the telephone server 66 receives an authentication error from the telephone server 62, or is unable to connect wirelessly with the telephone device 90 (e.g., wireless connection may not be achieved due to wireless connection with a plurality of other telephone devices, etc.), the telephone server 66 sends a connection error to the telephone device 90.

The telephone server 66 sends, to the telephone device 90, a telephone server list 137 including the URLs of the neighbouring telephone servers 64, 68 stored in the storing unit 78. Upon receiving the telephone server list 137, the telephone device 90 checks whether the URIs of the telephone servers 64, 68 are stored in the connection information table 107. If the URI of the telephone server 64 is not stored in the connection information table 107, the telephone device 90 sends a sub connection request 138 which includes its own SIP URI and information indicating that the connection request is the sub connection request to the telephone server 64. Similarly, if the URI of the telephone server 68 is not stored in the connection information table 107, the telephone device 90 sends a sub connection request 140 which includes its own SIP URI and information indicating that the connection request is the sub connection request to the telephone server 68. If the URI of a telephone server which has already achieved main connection or sub connection is included in the URIs of the telephone servers in the telephone server list 137, the telephone device 90 does not send a sub connection request to the telephone server corresponding to that URI. If a URI that is not included in the received identification signal is present in the URIs included in the telephone server list 137, the telephone device 90 need not send a connection request to the telephone server corresponding to that URI.

Upon receiving the sub connection request 138, the telephone server 64 checks whether the telephone device 90 has been authenticated. Specifically, the telephone server 64 checks whether the SIP URI of the telephone device 90 included in the connection request 138 is stored in the connection information table. If the telephone device 90 has been authenticated, the telephone server 64 sends a connection OK 142 to the telephone device 90. Next, the telephone server 64 stores an association of “sub connection” and the SIP URI of the telephone device 90 that is in the connection information table. If the telephone device 90 has not been authenticated, the telephone server 64 sends a connection error to the telephone device 90.

Similarly, upon receiving the connection request 140, the telephone server 68 checks whether the telephone device 90 has been authenticated. If the telephone device 90 has been authenticated, the telephone server 68 sends a connection OK 144 to the telephone device 90. Next, the telephone server 68 stores an association of “sub connection” and the SIP URI of the telephone device 90 that is in the connection information table. If the telephone device 90 has not been authenticated, the telephone server 68 sends a connection error to the telephone device 90.

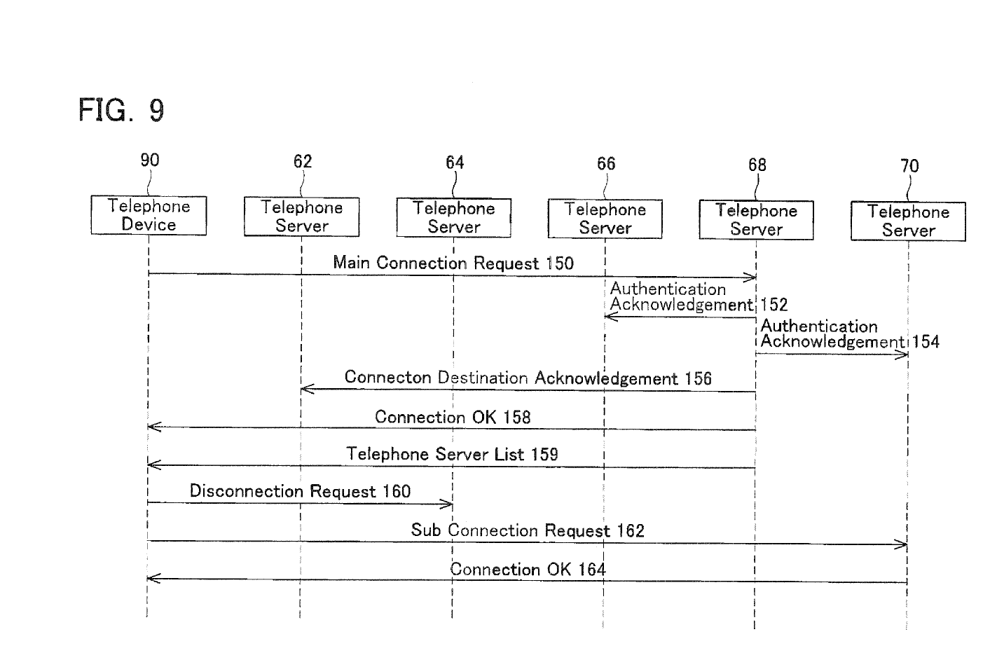

FIG. 9 explains a case where, from the state of FIG. 4, the telephone device 90 moves and the main connection destination of the telephone device 90 changes from the telephone server 66 to the telephone server 68. The processes performed by the devices 90, 62, 64, 66, 68, 70 are actually performed by the controlling units of those devices. If the signal strength of the identification signal sent from the telephone server 68 is greater than the signal strength of the identification signal sent from the telephone server 66, the telephone device 90 changes the main connection destination from the telephone server 66 to the telephone server 68. Alternatively, if the identification signal sent from the telephone server 66 can no longer be received, the telephone device 90 may change its main connection destination to the telephone server 68, whose identification signal it is currently receiving.

The telephone device 90 sends to the telephone server 68 the main connection request 150 which includes its own SIP URI and information indicating that the connection request is the main connection request. Upon receiving the main connection request 150, the telephone server 68 checks whether the SIP URI of the telephone device 90 included in the main connection request 150 is stored in the connection information table. If the SIP URI of the telephone device 90 is stored in the connection information table, the telephone server 68 has already received an authentication notice (the authentication acknowledgement 134 of FIG. 8) that includes the SIP URI of the telephone device 90. Consequently, the telephone server 68 does not perform the authentication process (password request, authentication request) of the telephone device 90. The URIs of the telephone servers 66, 70 neighbouring the telephone server 68 are stored in the storing unit of the telephone server 68. Based on the URIs of the telephone servers 66, 70 stored in the storing unit, the telephone server 68 sends authentication acknowledgements 152, 154 to the telephone servers 66, 70.

The case where the telephone server 66 receives the authentication acknowledgement 152 of the telephone device 90 sent from the telephone server 68 is the case where the telephone device 90 has the main connection with the telephone server 68. Upon receiving the authentication acknowledgement 152, the telephone server 66 changes the status of the SIP URI of the telephone device 90 stored in the connection information table 79 from “main connection” to “sub connection”. Further, upon receiving the authentication acknowledgement 154, the telephone server 70 stores, in the connection information table, the SIP URI of the telephone device 90 included in the authentication acknowledgement 154. The telephone server 68 determines the IP address assigned to the telephone device 90. The telephone server 68 sends, to the telephone server 62, a connection destination acknowledgement 156 including the SIP URI of the telephone device 90, its own URI, and the IP address assigned to the telephone device 90. Upon receiving the connection destination acknowledgement 156, the telephone server 62 changes the connection destination information stored in association with the SIP URI of the telephone device 90 in the registration information table to the URI of the telephone server 68. Further, the telephone server 62 changes the IP address stored in association with the SIP URI of the telephone device 90 in the registration information table to the received IP address.

Next, the telephone server 66 sends, to the telephone device 90, a connection OK 158 including the IP address assigned to the telephone device 90. Further, the telephone server 66 changes the status stored in association with the SIP URI of the telephone device 90 in the connection information table 79 from “sub connection” to “main connection”. The telephone device 90 sets the received IP address as its own IP address. The telephone device 90 changes “main connection” stored in association with the URI of the telephone server 66 in the storing unit 106 to “sub connection”, and changes “sub connection” stored in association with the URI of the telephone server 68 to “main connection”. Next, the telephone server 68 sends, to the telephone device 90, a telephone server list 159 including the URIs of the neighbouring telephone servers 66, 70 stored in the storing unit 74. At the time of receiving the telephone server list 159, the telephone device 90 may be connected with the telephone server 64. If the telephone device 90 is located within the wireless communication area 65 of the telephone server 64, the connection between the telephone device 90 and the telephone server 64 is maintained.

If the URI of the telephone server 64 is stored in the connection information table 107 and the URI of the telephone server 64 is not included in the telephone server list 159, the telephone device 90 sends a disconnection request 160 to the telephone server 64. The telephone device 90 deletes the URI of the telephone server 64 and the status associated therewith from the connection information table 107. Upon receiving the disconnection request 160, the telephone server 64 ends the communication session with the telephone device 90. Further, the telephone server 64 deletes the SIP URI of the telephone device 90 and the status associated therewith from the connection information table.

Next, the telephone device 90 sends a sub connection request 162 which includes its own SIP URI and information indicating that the connection request is the sub connection request to the telephone server 70 included in the telephone server list 159. Upon receiving the sub connection request 162, the telephone server 70 checks whether the SIP URI of the telephone device 90 included in the sub connection request 162 is stored in the connection information table. In a case where this has been verified, the telephone server 70 establishes a communication session enabling wireless communication with the telephone device 90. The telephone server 70 stores “sub connection” in association with the SIP URI of the telephone device 90 that is in the connection information table. The telephone server 70 sends a connection OK 164 to the telephone device 90. Consequently, the telephone device 90 stores an association of the URI of the telephone server 70 and “sub connection” in the connection information table 107. Since an association of the URI of the telephone server 66 and “sub connection” is stored in the connection information table 107, the telephone device 90 does not send a sub connection request to the telephone server 66.

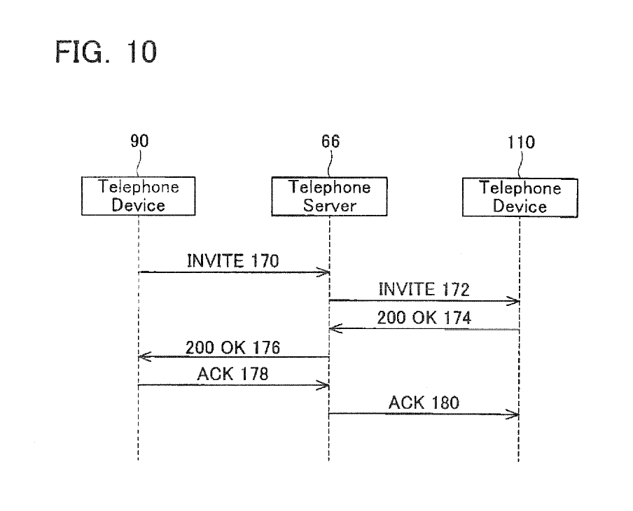

Next, a case in which telephone communication is started between the telephone device 90 and the telephone device 110 will be explained. The description below uses as an example the case where the telephone devices 90, 110 are located within the wireless communication area 67 of the telephone server 66, and have a main connection with the telephone server 66. In FIG. 10, the telephone device 90 sends INVITE to the telephone device 110. The processes performed by the devices 90, 110, 66 are actually performed by the controlling units of those devices. A user of the telephone device 90 performs a call preparation operation by operating the operating unit 98. The call preparation operation includes the user inputting the SIP URI of the telephone device 110 (e.g., selecting the SIP URI from a telephone directory stored in the storing unit 106, directly inputting the SIP URI, etc.), and then operating the hook key (call key).

In a case where the user performs the call preparation operation, the telephone device 90 sends, to the telephone server 66, INVITE 170 including the SIP URI of the telephone device 110 that is the destination thereof. The telephone server 66 has a main connection with the telephone device 90. The telephone server 66 does not transfer INVITE 170 to the telephone server 62 with which the telephone device 90 is registered. Instead, the telephone server 66 checks whether the telephone device 110, the destination of INVITE 170, has a main connection with the telephone server 66. In a case where the telephone server 66 has verified its main connection with the telephone device 110, the telephone server 66 transfers INVITE 172 to the telephone device 110.

Upon receiving INVITE 172, the telephone device 110 checks whether it can perform telephone communication. For example, if the telephone device 110 is performing telephone communication with a telephone device other than the telephone device 90, the telephone device 110 determines that it cannot perform telephone communication with the telephone device 90. Upon determining that it cannot perform telephone communication, the telephone device 110 sends “486 Busy Here” with the telephone device 90 as its destination. Upon verifying that it can perform telephone communication, the telephone device 110 sends “200 OK 174” to the telephone server 66 as a response to INVITE 172. The telephone server 66 relays “200 OK 176” to the telephone device 90. The telephone device 90 sends ACK 178 to the telephone server 66 as a response to “200 OK 176”. The telephone server 66 transfers ACK 180 to the telephone device 110. Further, the telephone server 66 sends the IP address of the telephone device 90 to the telephone device 110, and sends the IP address of the telephone device 110 to the telephone device 90. The telephone device 90 can thereby perform telephone communication with the telephone device 110 via the telephone server 66.

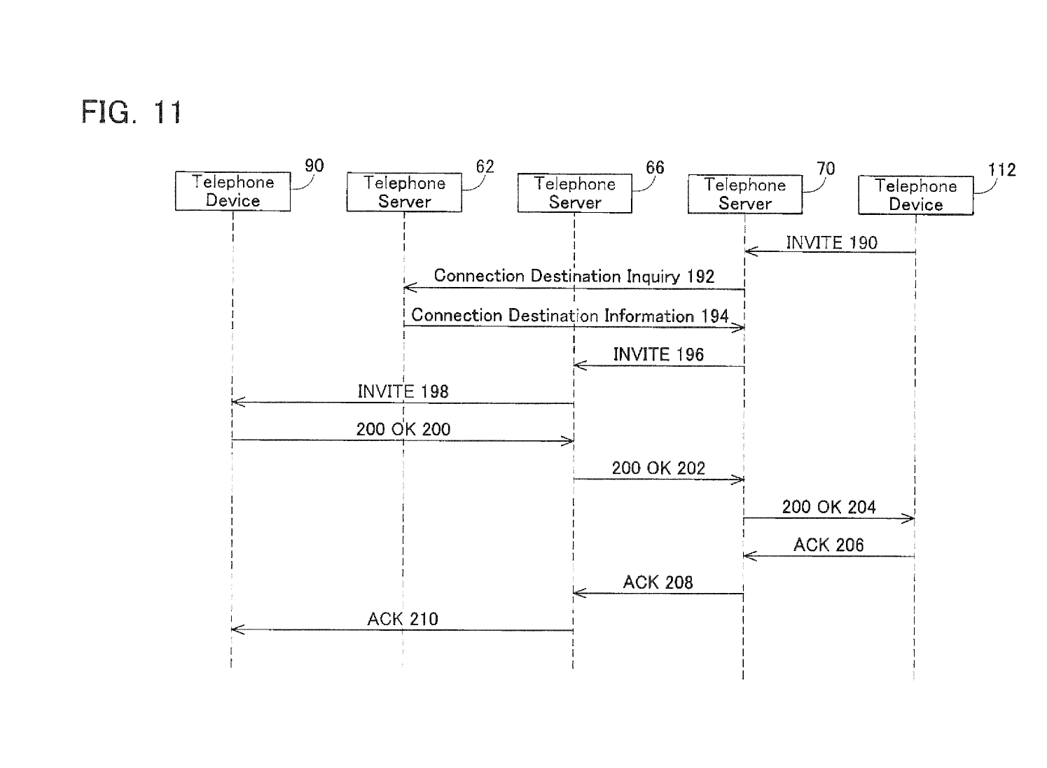

Next, a case in which telephone communication is started between the telephone device 90 and the telephone device 112 will be explained. The description below uses as an example the case where the telephone device 90 has a main connection with the telephone server 66 located within the wireless communication area 67 of the telephone server 66, and the telephone device 112 has a main connection with the telephone server 70 located within the wireless communication area 71 of the telephone server 70. In FIG. 11, the telephone device 112 sends INVITE to the telephone device 90. The processes performed by the devices 90, 112, 62, 66, 70 are actually performed by the controlling units of those devices. The user of the telephone device 112 performs the call preparation operation by operating the operating unit.

In a case where the user performs the call preparation operation, the telephone device 112 sends, to the telephone server 70, INVITE 190 that includes the SIP URI of the telephone device 90 which is the destination. The telephone server 70 checks whether the SIP URI included in INVITE 190 has a main connection with the telephone server 70. Upon verifying it does not have a main connection with the telephone device 90, the telephone server 70 sends, based on the SIP URI of the telephone device 90 (sip:aaa@server62.com), a connection destination inquiry 192 including the SIP URI of the telephone device 90 to the telephone server 62 with which the telephone device 90 is registered. The telephone server 70 does not transfer INVITE to the telephone server 62. Upon receiving the connection destination inquiry 192, the telephone server 62 specifies the URI of the telephone server 66 that is the connection destination stored in the registration information table in association with the SIP URI of the telephone device 90 included in the connection destination inquiry 192. As a response to the connection destination inquiry 192, the telephone server 62 sends connection destination information 194 including the specified URI of the telephone server 66 to the telephone server 70.

Upon receiving the connection destination information 194, the telephone server 70 stores an association of the URI of the telephone server 66 and the SIP URI of the telephone device 90 in the storing unit. The telephone server 70 sends INVITE 196 including the SIP URI of the telephone device 90 to the telephone server 66. Upon receiving INVITE 196, the telephone server 66 transfers INVITE 198 to the telephone device 90. Upon receiving INVITE 198, the telephone device 90 checks whether it is capable of telephone communication. If the telephone device 90 verifies it is capable of telephone communication, the telephone device 90 sends “200 OK 200” to the telephone server 66 as a response to INVITE 198. Upon receiving “200 OK 200”, the telephone server 66 transfers “200 OK 202” to the telephone server 70. Further, the telephone server 66 sends the IP address of the telephone device 90 to the telephone server 70. Upon receiving “200 OK 202”, the telephone server 70 transfers “200 OK 204” to the telephone device 112. Further, the telephone server 70 transfers the IP address of the telephone device 90 to the telephone device 112. The telephone device 112 sends ACK 206 to the telephone server 70 as a response to “200 OK 204”. The telephone server 70 transfers ACK 208 to the telephone server 66. Further, the telephone server 70 sends the IP address of the telephone device 112 to the telephone server 66. The telephone server 66 transfers ACK 210 to the telephone device 90. Further, the telephone server 66 transfers the IP address of the telephone device 112 to the telephone device 90. The telephone device 112 can thereby perform telephone communication with the telephone device 90 via the telephone servers 70, 66.

Next, processes of the telephone device 90 and the telephone device 112 will be explained for a case where, when the telephone devices 90 and 112 are performing telephone communication, the telephone server that is the main connection destination of the telephone device 90 changes from the telephone server 66 to the telephone server 68 by means of the process of FIG. 11. The processes performed by the devices 90, 112, 68, 70 are actually performed the controlling units of those devices. Upon receiving a connection OK (see the connection OK 158 of FIG. 9) from the telephone server 68, the telephone device 90 changes its own IP address to the IP address included in the connection OK 158. The telephone device 90 sends a connection destination changing acknowledgement 220 including the SIP URIs of the telephone devices 90, 112 and the changed IP address of the telephone device 90 to the telephone server 68. The telephone server 68 sends a connection destination changing acknowledgement 222 that includes its own URI and contents included in the connection destination changing acknowledgement 220 to the telephone server 70. The telephone server 70 changes the URI of the telephone server 66, stored in the storing unit in association with the SIP URI of the telephone device 90 included in the connection destination changing acknowledgement 222, to the URI of the telephone server 68.

The telephone server 70 transfers a connection destination changing acknowledgement 224 to the telephone device 112. The telephone device 112 changes the IP address of the telephone device 90 that is the telephone communication destination to the IP address included in the connection destination changing acknowledgement 224. The telephone device 112 sends “200 OK 226” to the telephone server 70 as a response to the connection destination changing acknowledgement 224. The telephone server 70 transfers “200 OK 228” to the telephone server 68. The telephone server 68 transfers “200 OK 230” to the telephone device 90.

In a case where an authentication OK (see the authentication OK 128 of FIG. 8) of the telephone device 90 is received from the telephone server 62 with which the telephone device 90 is registered, the telephone server 66 transfers commands and responses for performing telephone communication between the telephone device 90 and another telephone device. The telephone server 66 fulfills the role of SIP server of the telephone device 90 despite the telephone device 90 not being registered therewith. The telephone server 66 thereby does not need to transfer, to the telephone server 62, the commands and responses received from or sent to the telephone device 90. The communication load between the telephone server 66 and the telephone server 62 can thereby be reduced. Further, since the telephone server 66 does not transfer commands to the telephone server 62, the time is reduced between the telephone device 90 sending INVITE and telephone communication with another telephone device becoming possible.

Upon receiving an authentication OK of the telephone device 90 (see the authentication OK 128 of FIG. 8) from the telephone server 62 with which the telephone device 90 is registered, the telephone server 66 sends an authentication notice (see the authentication acknowledgements 132, 134 of FIG. 8) to the neighbouring telephone servers 64, 68. Further, the telephone server 66 sends a telephone server list including the URIs of the neighbouring telephone servers 64, 68 to the telephone device 90. The telephone device 90 sends a connection request (see the connection requests 138, 140 of FIG. 8) to the telephone servers 64, 68 included in the telephone server list. On the condition that the authentication notice has been received, the telephone servers 64, 68 establish a communication session with the telephone device 90. Consequently, if the telephone device 90 has moved within the wireless communication areas 65, 69 of the telephone servers 64, 68, the telephone device 90 can communicate wirelessly with the telephone servers 64, 68 without establishing a communication session with the telephone servers 64, 68.

If the telephone device 90 is connected with a telephone server not included in the telephone server list sent from the telephone server, the telephone device 90 sends a disconnection request (see the disconnection request 160 of FIG. 9) to the telephone server with which it is connected. The telephone server that received the disconnection request ends the connection with the telephone device 90. Consequently, the telephone server no longer needs to perform the process for maintaining communication with the telephone device.

In a case where the telephone server 70 receives INVITE having a destination of the telephone device 90, with which it is not connected, the telephone server 70 contacts the telephone server 62 with which the telephone device 90 is registered to identify the telephone server of the connection destination of the telephone device 90. The telephone server 70 stores the connection destination of the telephone device 90 sent from the telephone server 62. Consequently, if the telephone server 70 receives a command sent to the telephone device 90, the telephone server 70 need not contact the telephone server 62 at that occasion.

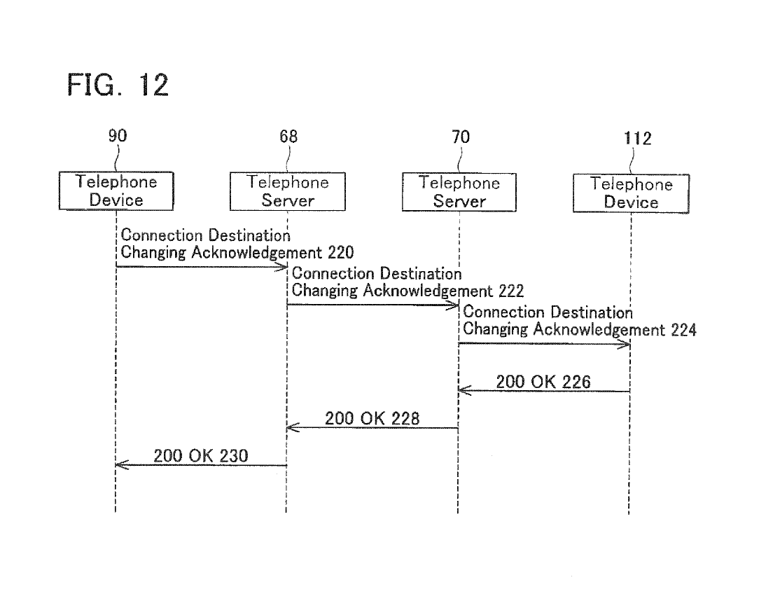

In a case where the telephone server of the main connection destination changes during telephone communication of the telephone device 90 and the telephone device 112, the IP address of the telephone device 90 changes. The telephone device 90 sends the connection destination changing acknowledgement (the connection destination changing acknowledgement 220 of FIG. 12) including its changed IP address to the telephone device 112 via the telephone servers 68, 70. Even if the IP address of the telephone device 90 changes, the telephone device 112 can thereby learn the changed IP address.

### Variants of the Above Embodiment are Given Below

Each of the telephone servers 62-70 need not store the URIs of its neighbouring telephone servers. For example, if the telephone server 62 is receiving identification information transmitted from another telephone server, the telephone server 62 may send an authentication notice to the telephone server that is the transmission source of the received identification information. Further, the telephone server 62 may send, as the telephone server list, the URI of the telephone server that is the transmission source of the identification information received by the telephone device to which the connection request was sent.

SIP is utilized in the above embodiment. However, another protocol may be utilized. For example, “H.323”, “MGCP (Media Gateway Control Protocol)”, “H.248/MEGACO (Media Gateway Control)”, etc. may be utilized.

If the telephone device sends a connection request to the telephone server, information indicating a main connection request or sub connection request need not be included in the connection request. That is, the main connection request and sub connection request that the telephone device sends to the telephone server may be identical. In this case, the telephone server may determine whether the connection request sent from the telephone device is a main connection request or a sub connection request. The controlling unit of the telephone server may make this determination based on, e.g., (1) to (3) below. (1) In a case where the connection request is received from a telephone device whose SIP URI is not stored in the connection information table, the connection request is determined to be a main connection request. (2) In a case where the connection request is received from a telephone device whose SIP URI is being stored in the connection information table in association with “sub connection”, the connection request is determined to be a main connection request. (3) In a case where the connection request is received from a telephone device whose SIP URI alone is being stored in the connection information table, the connection request is determined to be a sub connection request. Further, the connection request may be determined to be a sub connection request in conditions other than (1) to (3), e.g., in a case where the connection request is received from a telephone device whose SIP URI is being stored in the connection information table in association with “main connection”.

The telephone server may monitor that a telephone device is located within a wireless communication area by, e.g., regularly sending a signal to a telephone device with which a communication session is established. Alternatively, the telephone server may monitor that a telephone device is located within a wireless communication area by receiving a signal transmitted regularly from the telephone device. If unable to confirm that the telephone device is located within the wireless communication area, the telephone server may suspend the communication session with the telephone device. In this case, the telephone device need not send a disconnection request to the telephone server.

What is claimed is:

1. A first telephone server configured so as to be capable of communicating with a second telephone server with which a first wireless telephone device is registered, the first telephone server comprising:
an authentication information receiving unit configured to receive authentication information sent from the first wireless telephone device located within a wireless communication area of the first telephone server;
a first command sending unit configured to send a first command including the authentication information to the second telephone server;
a first response receiving unit configured to receive a first response, which includes an authentication result based on the authentication information included in the first command sent in response to the first command from the second telephone server;
a call request receiving unit configured to receive a call request, sent from the first wireless telephone device to a second wireless telephone device, by using a wireless communication;
a call request sending unit configured to send the call request to the second wireless telephone device by using the wireless communication without utilizing the second telephone server on a condition that the first response received by the first response receiving unit is a positive response which includes the authentication result indicating that authentication has succeeded and the second wireless telephone device is located within the wireless communication area;
a second response receiving unit configured to receive, by using the wireless communication, a second response sent in response to the first command from the second wireless telephone device, and
a second response sending unit configured to send the second response to the first wireless telephone device by using the wireless communication.

2. The first telephone server as in claim 1, further comprising:
a registration information storing unit configured to store registration information including the authentication information of a wireless telephone device;
a command receiving unit configured to receive a second command sent from the second telephone server and including authentication information of a third wireless telephone device, and
a response sending unit configured to send a positive response in response to the second command to the second telephone server on a condition that the authentication information of the third wireless telephone device including the second command is stored in the registration information storing unit.

3. The first telephone server as in claim 2, further comprising:
an authentication notice sending unit configured to send a first authentication notice, which indicates that authentication of the first wireless telephone device has succeeded, to a third telephone server on a condition that the first response received by the first response receiving unit is a positive response.

4. The first telephone server as in claim 3, further comprising:
an authentication notice receiving unit configured to receive a second authentication notice, sent from the second telephone server, which indicates that authentication of a fourth wireless telephone device has succeeded;
a session establishing unit configured to establish a session of the wireless communication with the fourth wireless telephone device on a condition that the second authentication notice has been received by the authentication notice receiving unit and the fourth wireless telephone device is located within the wireless communication area.

5. The first telephone server as in claim 1, further comprising:
an authentication notice sending unit configured to send a first authentication notice, which indicates that authentication of the first wireless telephone device has succeeded, to a third telephone server on a condition that the first response received by the first response receiving unit is a positive response.

6. The first telephone server as in claim 5, further comprising:
an authentication notice receiving unit configured to receive a second authentication notice, sent from the second telephone server, which indicates that authentication of a fourth wireless telephone device has succeeded;
a session establishing unit configured to establish a session of the wireless communication with the fourth wireless telephone device on a condition that the second authentication notice has been received by the authentication notice receiving unit and the fourth wireless telephone device is located within the wireless communication area.

7. The first telephone server as in claim 1, further comprising: an authentication notice receiving unit configured to receive a second authentication notice, sent from the second telephone server, which indicates that authentication of a fourth wireless telephone device has succeeded;
a session establishing unit configured to establish a session of the wireless communication with the fourth wireless telephone device on a condition that the second authentication notice has been received by the authentication notice receiving unit and the fourth wireless telephone device is located within the wireless communication area.

8. A computer readable medium storing a computer program, the computer program including instructions for ordering a computer mounted on a first telephone server configured so as to be capable of communicating with a second telephone server with which a first wireless telephone device is registered, to perform the following processes:
receive authentication information sent from the first wireless telephone device located within a wireless communication area of the first telephone server;
send a first command including the authentication information to the second telephone server;
receive a first response, which includes an authentication result based on the authentication information included in the first command, sent in response to the first command from the second telephone server;
receive a call request, sent from the first wireless telephone device to a second wireless telephone device, by using a wireless communication;
send the call request to the second wireless telephone device by using the wireless communication without utilizing the second telephone server on a condition that the first response is a positive response which includes the authentication result indicating that authentication has succeeded and the second wireless telephone device is located within the wireless communication area;
receive a second response sent in response to the first command from the second wireless telephone device by using the wireless communication, and
send the second response to the first wireless telephone device by using the wireless communication.
